(19) United States
(12) Patent Application Publication
(10) Pub. No.: US 2023/0028841 A1
(43) Pub. Date: Jan. 26, 2023

(54) CONDITIONALLY TRANSPARENT TOUCH CONTROL SURFACE

(71) Applicant: Karma Automotive LLC, Irvine, CA (US)

(72) Inventors: Michael Groene, Irvine, CA (US); David Witt, Newport Beach, CA (US); Andre Franco Luis, Orange, CA (US); Adelaide Begalli, San Mateo, CA (US)

(73) Assignee: Karma Automotive, LLC, Irvine, CA (US)

(21) Appl. No.: 17/758,252

(22) PCT Filed: Apr. 13, 2020
(86) PCT No.: PCT/US2020/027997

§ 371 Date: Jun. 30, 2022

Related U.S. Application Data
(60) Provisional application No. 62/833,649, filed on Apr. 13, 2019.

(51) Int. Cl. B60K 35/00

(52) U.S. Cl. CPC B60K 35/00; B60K 2370/122; B60K 2370/119; B60K 2370/1438; B60K 2370/1446; B60K 2370/149; B60K 2370/1531; B60K 2370/1533; B60K 2370/195

(57) ABSTRACT

A conditionally transparent touch control surface including a base layer, a display layer, and a surface layer. The display layer includes a plurality of display areas each with an OFF state and an ON state. The surface layer covers the plurality of display areas and each display area is visible through the surface layer only while that display area is in the ON state. The control surface is flexible and contours to a shape such as the shape of an interior surface of a vehicle. The display areas can be reconfigured to match with a specific function and to display a specific icon, and the display areas can be hidden from view when not in use.

### CROSS-REFERENCE TO RELATED APPLICATIONS

The present application claims priority to and the benefit of U.S. Provisional Patent Application No. 62/833,649 filed on Apr. 13, 2019. The present application is related to the concurrently filed applications entitled: Humanized Communication Interface, filed on Apr. 13, 2019 and assigned U.S. Patent Application No. 62/833,654; and Personalized Seating Zone System, filed on Apr. 11, 2019 and assigned U.S. Patent Application No. 62/832,477. The foregoing applications are incorporated by reference herein in their entirety.

### BACKGROUND

The present disclosure relates to a conditionally transparent touch control surface for a vehicle.

Modern vehicles include a large number of systems, with each system including a large number of system settings for various options. As the sophistication of each system increases, the number of controls to present for adjusting system settings also increases. While it is possible to design elegant and tasteful control surfaces for this purpose, these designs often disrupt a minimalist approach to vehicle interior design. Further, current systems do not provide for reconfiguring the visual design of their embedded control surfaces after installation.

Display screens with graphic user interfaces offer the flexibility needed for a reconfigurable control scheme, but these are restricted in place to a central console, removing the advantages of placing a control interface in a contextually relevant location. Even if this is an acceptable trade-off, display screens still take up space that may disrupt the vehicle interior design scheme.

It is desirable to produce a control surface that is reconfigurable and unobtrusive, such that user interface elements of the control surface are only visible when wanted or needed.

### SUMMARY

Disclosed herein is a conditionally transparent touch control surface. According to one embodiment, the control surface includes a base layer, a display layer, and a surface layer. According to one embodiment, the display layer includes a plurality of display areas each with an OFF state and an ON state. According to one embodiment, the surface layer covers the plurality of display areas and each display area is visible through the surface layer only while that display area is in the ON state. According to one embodiment, the control surface is flexible and contours to the shape of another surface. According to one embodiment, the control surface is flexible and contours to the shape of an interior surface of a vehicle.

In another disclosed embodiment, the display layer is at least partially a touchscreen including a plurality of display areas each with an OFF state and an ON state.

In another disclosed embodiment, at least one of the plurality of display areas is a mechanical switch with a screen.

In another disclosed embodiment, at least one display area corresponds to a function. In another disclosed embodiment, the function is a function of a vehicle. In another disclosed embodiment, the correspondence of the at least one display area to a function is reconfigurable. In another disclosed embodiment, the at least one display area displays an icon related to its corresponding function. In another disclosed embodiment, the icon of the at least one display area is reconfigurable.

In another disclosed embodiment, at least one display area responds to a touch command.

In another disclosed embodiment, at least one display area switches between the ON state and the OFF state upon receiving control instructions from a display area management system. In another disclosed embodiment, the display area management system controls the at least one display area to switch between the ON state and the OFF state based on a tracked eye movement of a user.

Other aspects, features, and techniques will be apparent to one skilled in the relevant art in view of the following detailed description of the embodiments.

### BRIEF DESCRIPTION OF THE DRAWINGS

The features, objects, and advantages of the disclosed embodiments will become more apparent from the detailed description set forth below when taken in conjunction with the drawings in which like reference characters identify correspondingly throughout and wherein:

FIG. 1 is a perspective view of an exemplary embodiment of a vehicle in which a conditionally transparent touch control surface may be installed.

FIG. 2 is a perspective view of an exemplary embodiment of a vehicle interior in which a plurality of conditionally transparent touch control surfaces may be installed.

FIGS. 3A-3E are perspective views of an exemplary embodiment of a conditionally transparent touch control surface. FIG. 3A is a perspective view of the exemplary conditionally transparent touch control surface. FIG. 3B is an exploded perspective view of the exemplary conditionally transparent touch control surface. FIG. 3C is an exploded perspective view of the exemplary conditionally transparent touch control surface, wherein the display areas of the conditionally transparent touch control surface have an updated set of icons. FIG. 3D is a perspective view of another exemplary conditionally transparent touch control surface. FIG. 3E is a perspective view of another exemplary conditionally transparent touch control surface having different locations for the display areas.

FIGS. 4A-4E are side section views of an exemplary embodiment of a conditionally transparent touch control surface, taken along the line 4-4. FIGS. 4A-4E are side section views of exemplary embodiments of a conditionally transparent touch control surface, wherein the display layer of the conditionally transparent touch control surface is a touchscreen. FIGS. 4B-4E are side section views of an exemplary embodiment of a conditionally transparent touch control surface, wherein the display layer of the conditionally transparent touch control surface comprises a plurality of display layer elements.

FIG. 5 is a side section view of an exemplary embodiment of a conditionally transparent touch control surface, wherein the display layer of the conditionally transparent touch control surface includes discrete mechanical switches functioning as display areas.

FIG. 6 is a graphical representation of an exemplary embodiment of a conditionally transparent touch control surface and related components.

FIG. 7 is a flow chart depicting an exemplary process for the operation of a conditionally transparent touch control surface.

FIG. 8 is a schematic of a capacitive touch system including a conditionally transparent touch control surface.

### DETAILED DESCRIPTION

One aspect of the disclosure is directed to a conditionally transparent touch control surface for a vehicle.

References throughout this document to “one embodiment,” “certain embodiments,” “an embodiment,” or similar term mean that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. For example, two or more of the innovative devices described herein may be combined in a single device, but the application is not limited to the specific exemplary combinations of a conditionally transparent touch control surface for a vehicle that are described herein.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The character “N” refers hereinafter to the last member of a set or the total count of members in a set. The character “X” refers hereinafter to a variable member of a set. The characters “A”, “B”, “C”, etc. refer to a specific but otherwise undefined member of a set.

A detailed description of various embodiments is provided; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the disclosed embodiments.

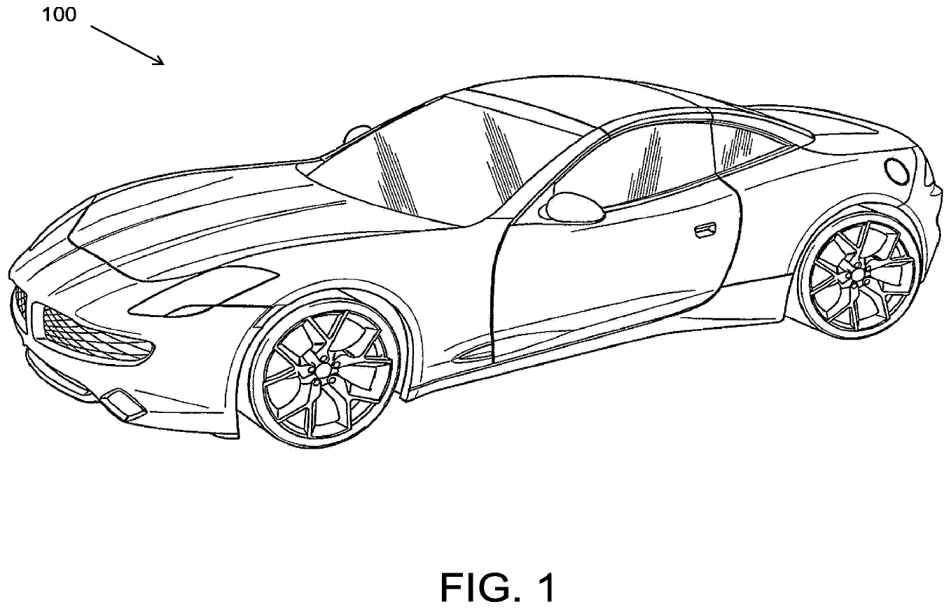

FIG. 1 is a perspective view of an exemplary embodiment of a vehicle 100 in which a conditionally transparent touch control surface 200 may be installed. The vehicle 100 shown in FIG. 1 is depicted as a sedan, but the conditionally transparent touch control surface 200 may be used with any other vehicle featuring interior surfaces that may serve as control panels.

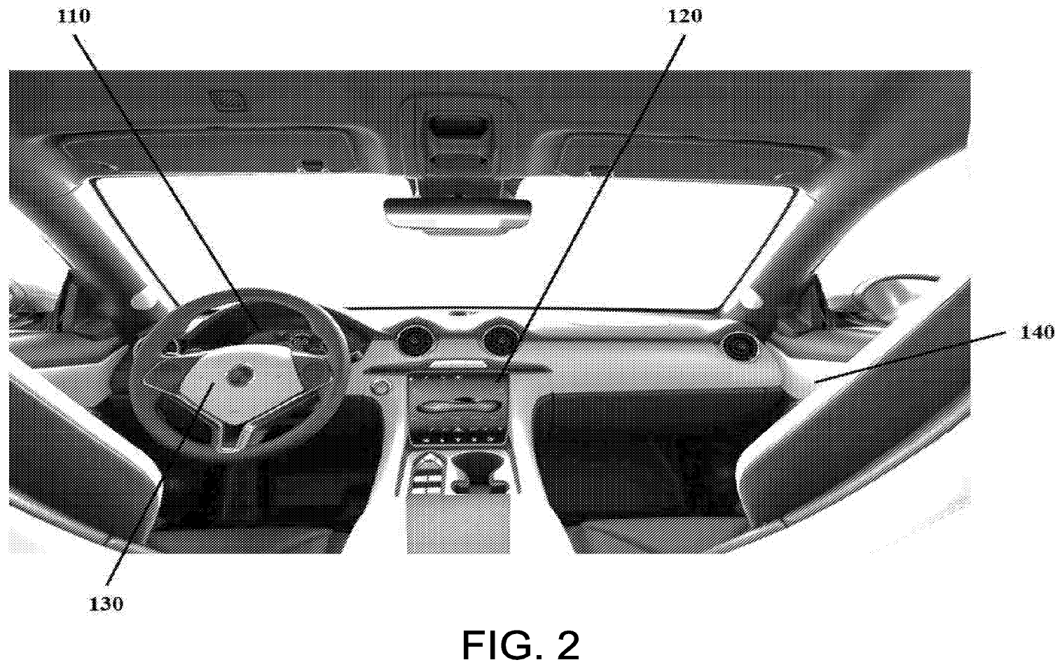

FIG. 2 is a perspective view of an exemplary embodiment of a vehicle interior in which a plurality of conditionally transparent touch control surfaces 200 may be installed. According to one embodiment, a conditionally transparent touch control surface 200 may be installed on a variety of vehicle interior surfaces, including but not limited to an instrument panel 110, a center console 120, a steering wheel 130, and a door panel 140. Each of the conditionally transparent touch control surfaces 200 may be flexible; a conditionally transparent touch control surface 200 may wrap around the entire surface of a vehicle interior surface while contouring around the shape of the vehicle interior surface and without requiring multiple conditionally transparent touch control surface 200 sections or elements that would create a seam.

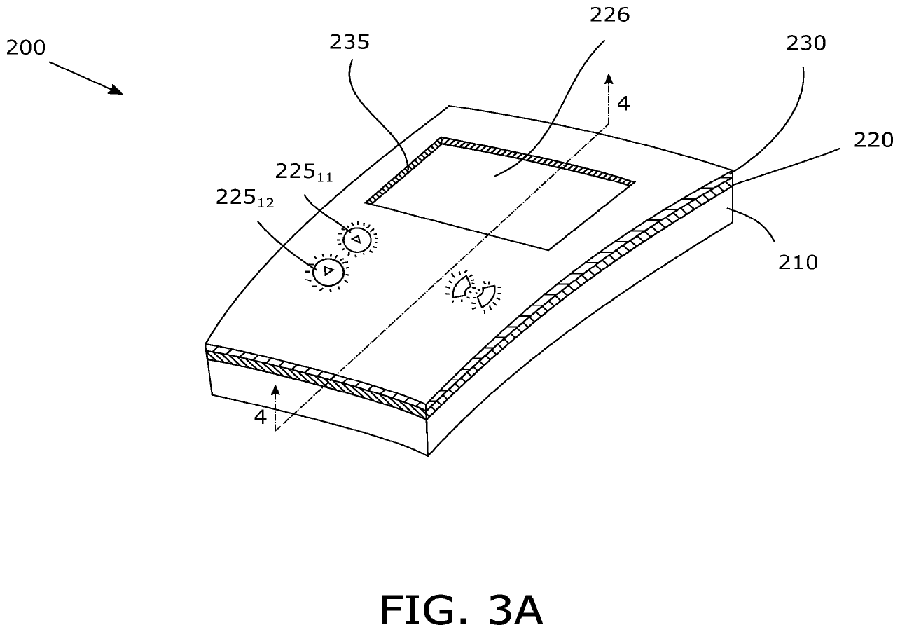

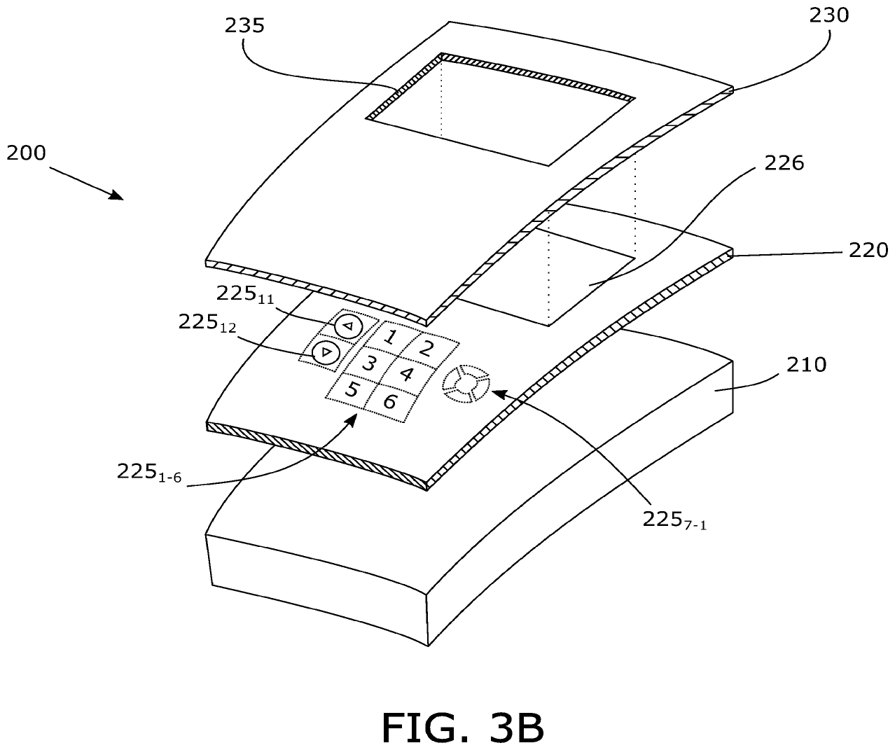

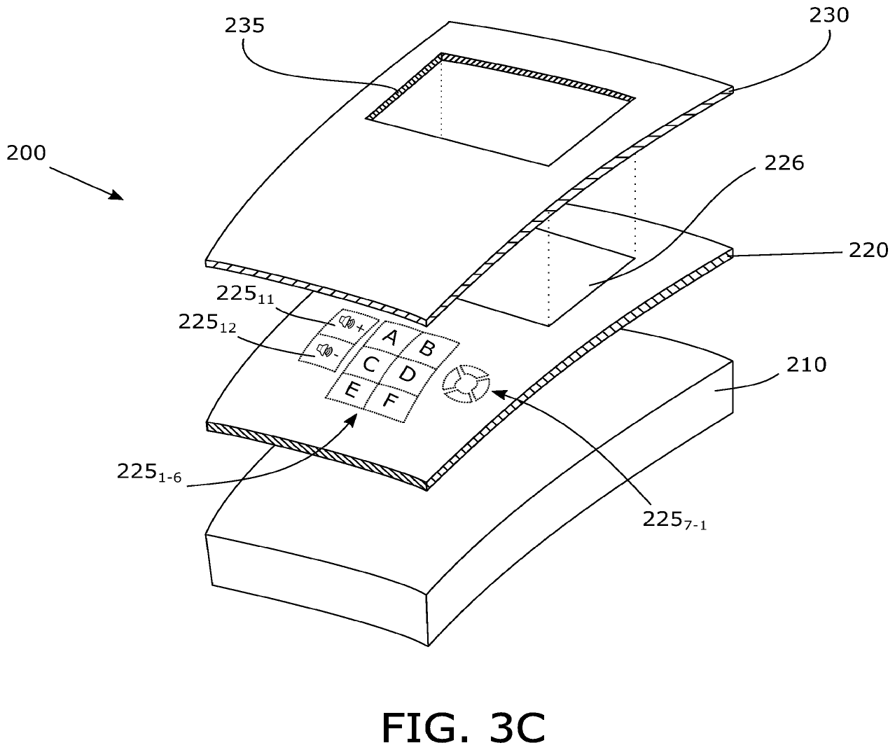

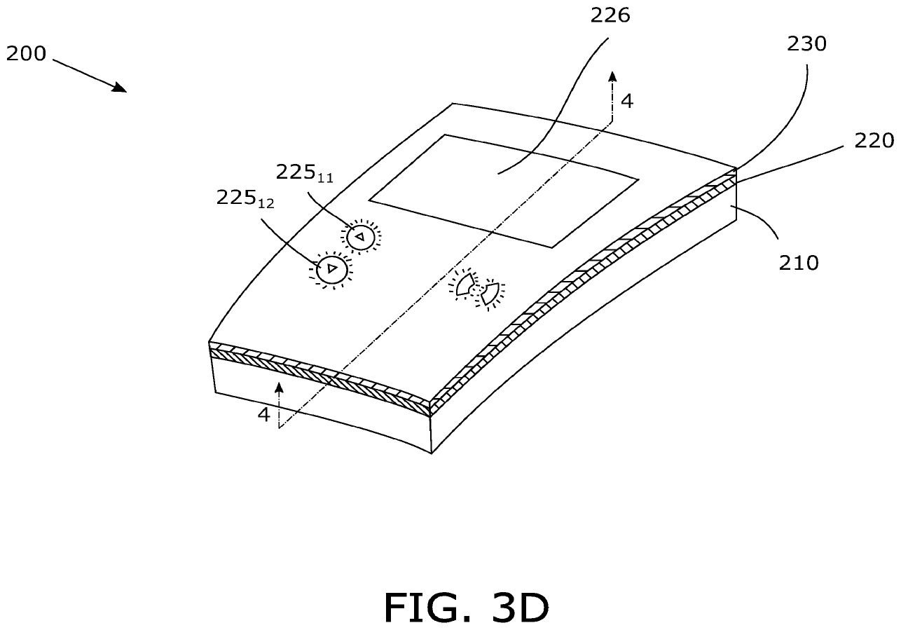

FIGS. 3A-3E are perspective views of an exemplary embodiment of a conditionally transparent touch control surface 200. FIG. 3A is a perspective view of the exemplary conditionally transparent touch control surface 200. FIG. 3B is an exploded perspective view of the exemplary conditionally transparent touch control surface 200. FIG. 3C is an exploded perspective view of the exemplary conditionally transparent touch control surface 200, wherein the display areas 2251-N of the conditionally transparent touch control surface 200 have an updated set of icons.

According to one embodiment, the conditionally transparent touch control surface 200 includes three layers: a base layer 210, a display layer 220, and a surface layer 230. The surface layer 230 may be placed on top of the display layer 220, and the display layer 220 may be placed on top of the base layer 210.

In one embodiment, the base layer 210 may be a structural layer designed to support the shape of the conditionally transparent touch control surface 200. The base layer 210 may be constructed of, for example, foam.

In one embodiment, the display layer 220 may be the primary interface layer — the layer which provides information to and receives feedback from an occupant of the vehicle 100. The display layer 220 may at least partially comprise a flexible touchscreen, wherein at least a portion of the touchscreen is divided into a plurality of display areas 2251-N, with the borders of each display area 225X marked in FIGS. 3B and 3C by dashed lines. Each of the display areas 225X in the plurality of display areas 2251-N may have a different size and shape with respect to the other display areas 2251-N. Each of the display areas 225X in the plurality of display areas 2251-N may have an “off” state and an “on” state. A display area 225X in the OFF state may be completely unilluminated, while a display area 225X in the ON state may be at least partially illuminated. The display layer may be a flexible OLED type layer. Thus, the display layer may be placed on a flexible substrate which may be either plastic, metal or flexible glass. The plastic and metal panels may be light, thin and very durable.

The surface layer 230 may be a concealing layer designed to cover the plurality of display areas 2251-N such that while a display area 225X is in the OFF state, the surface layer 230 may completely conceal the display area 225X. In one embodiment, while a display area 225X is in the OFF state, the portion of the surface layer 230 immediately above the display area 225X appears opaque and elements of the display area 225X are invisible to observers. In one embodiment, a display area 225X in the ON state emits light that is bright enough to be seen through the surface layers 230 of the conditionally transparent touch control surfaces 200. For example, the volume control display areas 22511-12 are in the ON state in FIG. 3A and are therefore visible through the surface layer 230, while the remaining display areas 2251-10 (depicted in FIGS. 3B and 3C) are in the OFF state in FIG. 3A and are therefore not visible through the surface layer 230. The surface layer 230 may further be designed to allow a display area 225X (such as the dedicated display area 226) to be visible regardless of ON state or OFF state through the section of the surface layer 230 that covers the display area 225X. The surface layer 230 may comprise a traditionally opaque material such as, for example, wood, metal, plastic, leather, or stone. The surface layer 230 may comprise two or more materials, in accordance with the trim design of the vehicle interior.

It should be noted that although FIGS. 3A-3C depict a fixed number of display areas 225, the number of display areas in the plurality of display areas 2251-N is limited only by the number of distinct sections into which the display layer 220 may be separated.

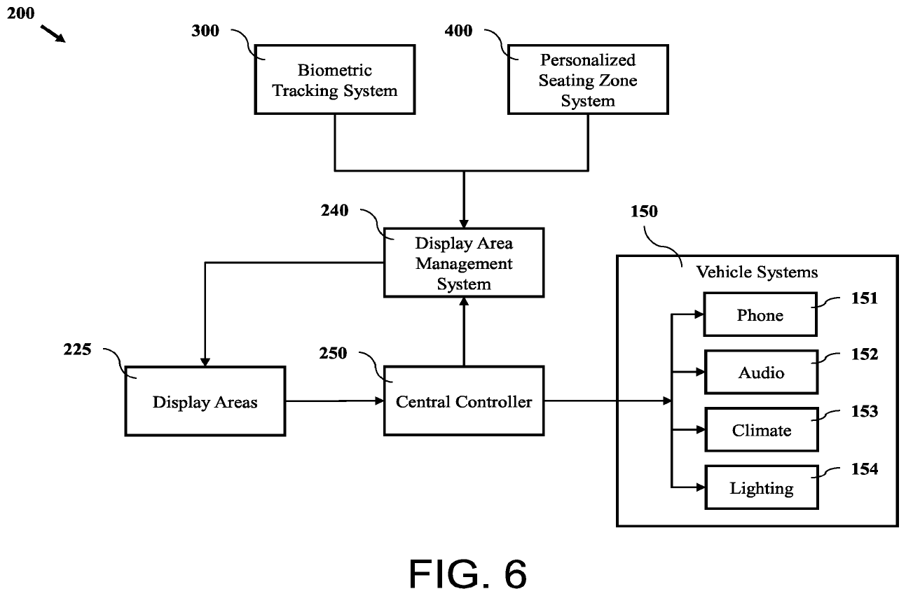

According to one embodiment, each display area 225X in the plurality of display areas 2251-N corresponds to a function of the vehicle 100. A display area 225X may display an icon related to its corresponding function when that display area 225X is in the ON state. The display area 225X may be further designed to respond to a touch command from an occupant of the vehicle 100, such that the touch command controls some aspect of the corresponding function. The corresponding function may relate to one of a plurality of vehicle systems 150 (see FIG. 6), such as a sound system, climate system, or navigation system.

According to one embodiment, the corresponding function of a display area 225X may be reconfigurable, such that the display area 225X is reconfigured to correspond to a different function. According to one embodiment, the displayed icon of a display area 225X may be reconfigurable. For example, an occupant of the vehicle 100 may change the displayed icon of one or more display areas 225X from a summer theme to an autumn theme. The display areas 225ₓ may be located in various locations as shown in FIG. 3E.

According to one embodiment, the surface layer 230 may include at least one cutout 235 to allow at least one section of the display layer 220 to be visible at all times. The one section of the display layer 220 may be a dedicated display area 226. This may be useful for setting aside a section of the display layer 220 to act as a display screen, wherein the display screen serves to display sophisticated image data that requires clarity and/or resolution beyond basic iconography. This sophisticated image data may include, for example, a navigation display or a control menu.

FIG. 3D is a perspective view of another exemplary embodiment without a cutout 235. In this embodiment shown in FIG. 3D, the display area 226 is directly projected onto the surface layer 230 without a cutout in similar manner to display area 225x.

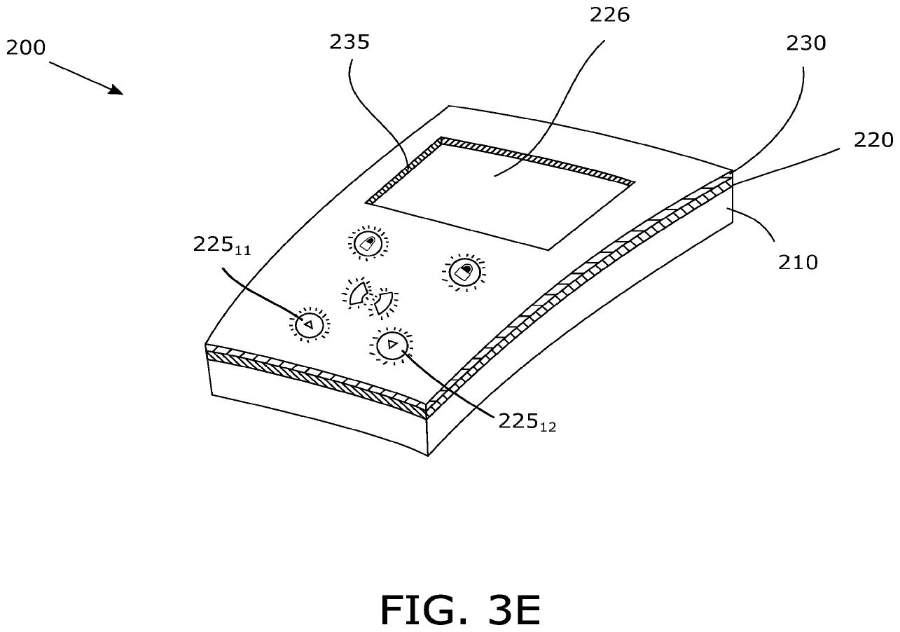

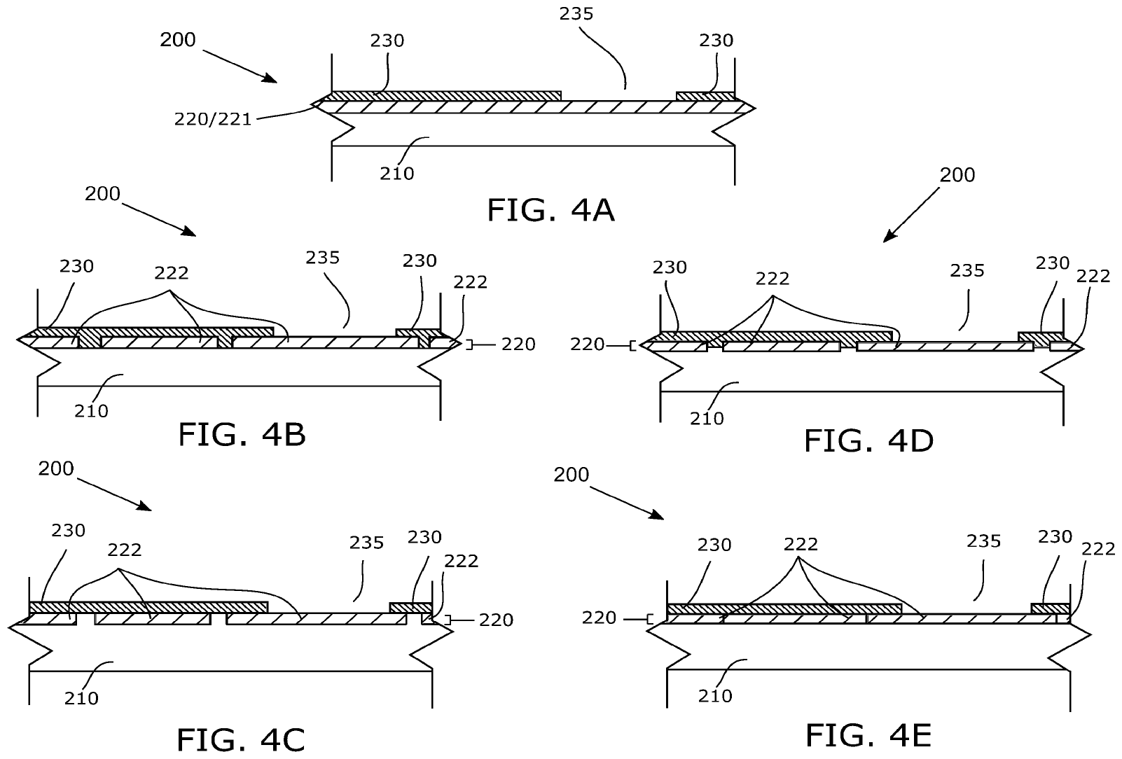

FIGS. 4A-4E are side section views of an exemplary embodiment of a conditionally transparent touch control surface 200, taken along the line 4-4. FIG. 4A is a side section view of an exemplary embodiment of a conditionally transparent touch control surface 200, wherein the display layer 220 of the conditionally transparent touch control surface 200 is a single touchscreen 221. According to one embodiment, the single touchscreen 221 is a flexible touchscreen that is capable of contouring to any vehicle interior surface. According to one embodiment, the display layer 220 may be mounted above a base layer 210 and beneath a surface layer 230. The surface layer 230 may include a cutout 235 to allow at least one section of the display layer 220 to be visible at all times.

FIGS. 4B-4E are side section views of an exemplary embodiment of a conditionally transparent touch control surface 200, wherein the display layer 220 of the conditionally transparent touch control surface 200 comprises a plurality of display layer elements 222. Portions of the surface layer 230 may fill in the gaps between the plurality of display layer elements 222 (as per FIG. 4B), or portions of the base layer 210 may fill in the gaps instead (as per FIG. 4C), or portions of both the surface layer 230 and portions of the base layer 210 may fill in the gaps together (as per FIG. 4D). According to one embodiment, the display layer elements 222 may be placed next to each other without any gap filler material (as per FIG. 4E). Each display layer element 222 may include a plurality of display areas 225.

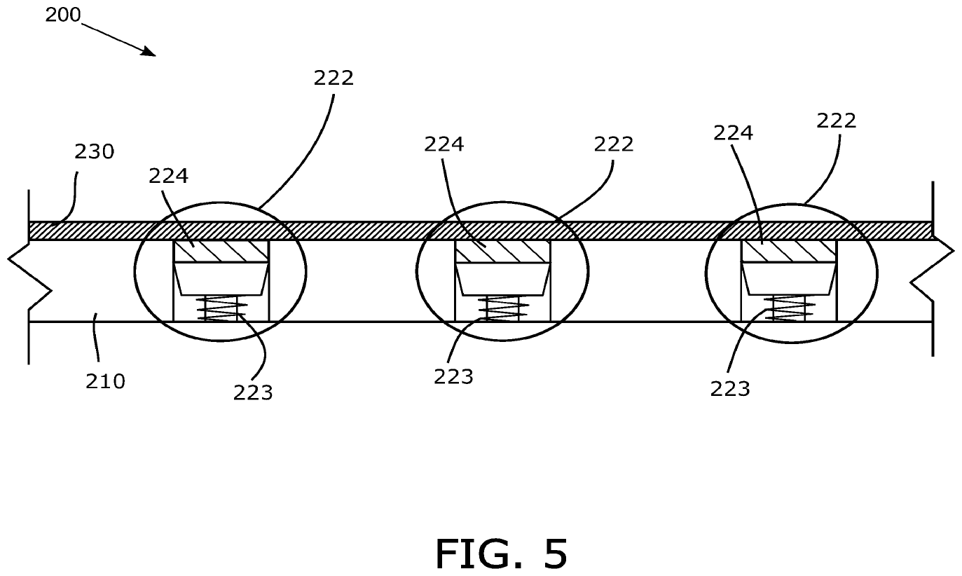

FIG. 5 is a side section view of an exemplary embodiment of a conditionally transparent touch control surface 200, wherein the display layer 220 of the conditionally transparent touch control surface 200 includes a plurality of discrete mechanical switches 223 each functioning as display area elements 222. According to one embodiment, each discrete mechanical switch 223 may include a screen 224 that allows each discrete mechanical switch 223 to operate similarly to the display areas 225 disclosed above.

FIG. 6 is a graphical representation of an exemplary embodiment of a conditionally transparent touch control surface 200 and related components. According to one embodiment, a display area management system 240 may individually control, by means of control instructions, whether each display area 225 is in the ON state or OFF state, and further control which display areas 225 are receptive to touch commands. According to one embodiment, the display area management system 240 may configure, by means of configuration instructions, what vehicle functions each display area 225 corresponds to and what icons each display area 225 displays while in the ON state. The display area management system 240 may further reconfigure each display area 225 at any time. The display area management system 240 may include a controller (not shown) configured to control the change of each the display areas from the OFF state to the ON state based on sensing a condition of a person interacting with the control surface.

In one embodiment, the display area management system 240 may receive control instructions from a biometric tracking system 300. The biometric tracking system 300 may be an eye tracking system such as the system disclosed in U.S. Patent Application No. 62/833,654 or a proximity sensor. According to one embodiment, the biometric tracking system 300 may track the eyes of an occupant of the vehicle 100 to determine which display areas 225 should be in the ON state and turn the corresponding display areas 225 in the ON state. The biometric tracking system 300 may track occupant's eye to identify the occupant's line of sight or focus and instruct the display area management system 240 to activate corresponding display areas 225 that may be of interest to the occupant. As an example, if the occupant is looking at the center console 120, then the biometric tracking system 300 may instruct the display area management system 240 to switch all display areas 225ₓ on the center console 120 to the ON state and switch all other display areas 225ₓ to the OFF state. A proximity sensor may also track or sense movements of the occupant near the display areas. The proximity sensor of the biometric tracking system 300 may instruct the display area management system 240 to activate one or more the corresponding display areas 225 that are required to be in the ON state. According to another embodiment, the display area management system 240 may receive control instructions and/or configuration instructions from a personalized seating zone system 400 such as the system disclosed in U.S. Patent Application No. 62/832,477. The seating zone system 400 may allow occupants to configure the display areas 225 to different functions.

The proximity sensor may be a capacitive type sensor that includes a sensing element and a shielding element and conductive carriers or traces. The proximity sensor may be from a single uniform layer of metal using subtractive methods such as silk screen printing, photoengraving, or PCB milling. In other embodiments, an additive or semi-additive method such as physical vapor deposition (PVD), chemical vapor deposition (CVD), electrolytic plating, electroless plating, or another suitable metal deposition process is used. The conductive traces can connect the proximity sensor to a controller or CPU. Shielding element may include shielding areas that provide an electromagnetic shield substantially surrounding sensing element in each direction other than the direction which sensing is desired. The shielding areas may surround the sensing element on the bottom and sides, and a body part is detected when disposed over sensing element. The proximity sensor may be used to sense a person's finger, but also a palm, face, or other conductive object is also capable of being detected. The proximity sensor may be incorporated into the display layer 220.

In one embodiment, the display areas 225 send control signals to a central controller 250 based on interactions that occupants of the vehicle 100 have with the display areas 225. These control signals may be control signals for controlling the operation of a plurality of vehicle systems 150 and the central controller 250 may interpret the control signals and/or forward the control signals to the appropriate vehicle system in the plurality of vehicle systems 150. The plurality of vehicle systems 150 may include, for example, a phone system 151, an audio system 152, a climate system 153, and a lighting system 154. The central controller 250 may further control the function of the display area management system 240. In one embodiment, control of the function of the display area management system 240 may be tied to at least one display area 225.

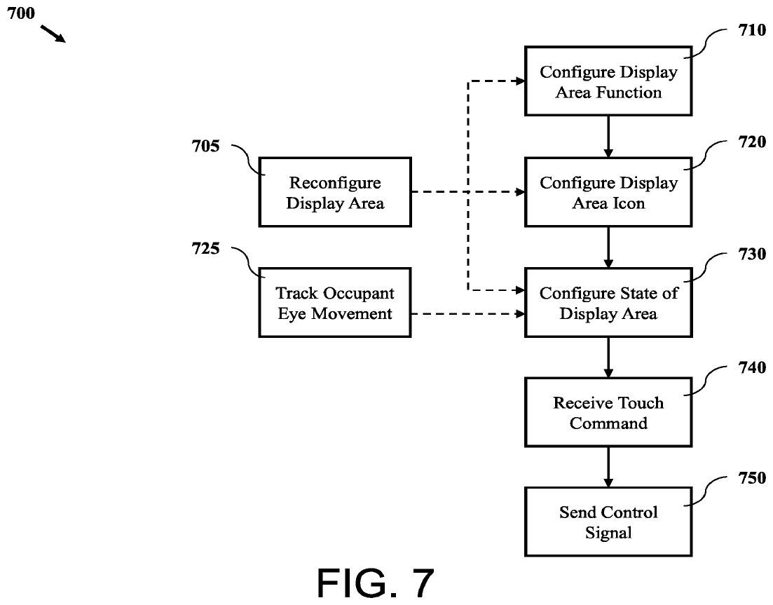

FIG. 7 is a flow chart depicting an exemplary process 700 for the operation of a conditionally transparent touch control surface 200, and in particular the operation of an individual display area 225 of the conditionally transparent touch control surface 200.

At block 710, according to one embodiment, the process 700 configures the function of each display area 225. Configuring the function of each display area 225 may include establishing a correspondence between each display area 225 and a function of the vehicle 100. Functions of the vehicle 100 may include, for example, control of a plurality of vehicle systems 150 within the vehicle 100.

At block 720, according to one embodiment, the process 700 configures the icons of each display area 225. Configuring the icons of each display area 225 may be handled based on the corresponding vehicular function of the display area 225. For example, a display area 225 corresponding to control of a lighting system of the vehicle 100 may be configured to have a lightbulb icon.

At block 730, according to one embodiment, the process 700 configures the state of selected display areas 225. Configuring the state may switch selected display areas 225 between the ON state and the OFF state. Selection of which display areas 225 to configure may depend on the process 700 at block 705. At block 705, a user may reconfigure the button to a desired function from a list of preselected function. Configuring the state of selected display areas 225 may be directed to the purpose of only enabling a display area 225 (and its corresponding functionality) when that display area is requested or required.

At block 740, according to one embodiment, the process 700 may receive a touch command at one or more of the display areas 225 previously set to the ON state at block 730. The touch command may be an occupant of the vehicle 100 interacting with one or more of the display areas 225. Thus, the display area may include a touch sensor and/or switch for receiving the command. A mechanical switch is described above, however a capacitive type touch sensor and switch may be alternatively implemented. The display layer may include both a display capability and a capacitive sensing capability such is commonly used and well known in current multi-touch display. For example, an integrated Silicon-OLED display and touch sensor panel can form the display layer and be mounted on a substrate. This the display layer may include an array of transistors, one or more metallization layers, one or more vias, an OLED stack, color filters, touch sensors, and additional components and circuitry. Additional components and circuitry can include an electrostatic discharge device, a light shielding, a switching matrix, one or more photodiodes, a near-infrared detector and near-infrared color filters. The integrated Silicon-OLED display and touch sensor panel or display layer can be further configured for near-field imaging, optically-assisted touch, and fingerprint detection. In some examples, a plurality of touch sensors and/or display pixels can be grouped into clusters, and the clusters can be coupled to a switching matrix for dynamic change of touch and/or display granularity.

At block 750, according to one embodiment, the process 700 running on a controller may send a control signal from each display area 225 that previously received a touch command at block 740. The control signal may be a control signal for adjusting the performance of the corresponding vehicular function of a display area 225 that received a touch command.

The process 700 may include additional means to control the operation of the conditionally transparent touch control surface 200. At block 705, according to one embodiment, the process 700 may reconfigure one or more display areas 225. Reconfiguring may include iterating through blocks 710, 720, and 730 according to the instructions of a control system such as, for example, a personalized seating zone system as disclosed in U.S. Patent Application No. 62/832,477. Reconfiguring may set a selection of display areas 225 to the ON state and another selection of display areas 225 to the OFF state according to user preference, or according to a user preference profile. Reconfiguring may swap out the icons for each display area 225 to a new library of icons. At block 725, according to one embodiment, the process 700 may track the eye movement of an occupant of the vehicle 100 to determine how to configure the state of each display area 225 at block 730. For example, the process 700 may switch any display area 225 an occupant of the vehicle 100 is looking at to the ON state, and all other display areas 225 to the OFF state. Tracking the eye movement of an occupant of the vehicle 100 may make use of a biometric tracking system like the system disclosed in U.S. Patent Application No. 62/833,564.

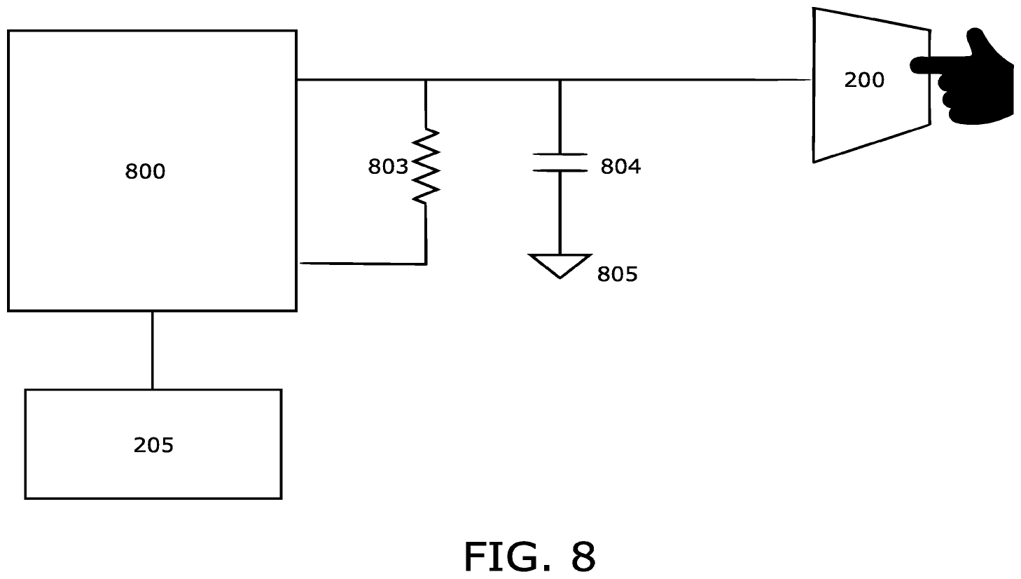

FIG. 8 shows a simplified schematic of an embodiment of the touch control surface 200 utilizing an exemplary capacitive touch system circuit. This circuit may include a resistor microcontroller 800, a resistor 803, a capacitor 804 and ground 805. When the occupant touches the control surface in the circuit, it acts as another capacitor added to the circuit. This increases the overall capacitance of the circuit and interferes with the charging and discharging times of the circuit. Thus, the difference in the charge-discharge time across the circuit will signify the presence of the touch by user. The microcontroller 800 monitors the differences in charge and discharge times of the circuit, and when this value deviates, it sends signals to the central controller 250 an input signal corresponding to the occupant's touch. The microcontroller 800 may send data signals to the central controller 250 of the vehicle to control different vehicle system as shown in FIG. 6.

Certain embodiments are described herein as including controllers or processors. These processors may include either software modules (e.g., code embodied on a machine-readable medium or in a transmission signal) and/or controllers. A controller may be a tangible unit capable of performing certain operations and may be configured or arranged in a certain manner. In example embodiments, one or more computer systems (e.g., a standalone, client or server computer system) or one or more controllers of a computer system (e.g., a processor or a group of processors) may be configured by software (e.g., an application or application portion) as a controller that operates to perform certain operations as described herein.

In various embodiments, a controller or controller may be implemented mechanically or electronically. For example, a controller may comprise dedicated circuitry or logic that is permanently configured (e.g., as a special-purpose processor, such as a field programmable gate array (FPGA) or an application-specific integrated circuit (ASIC)) to perform certain operations. A controller may also comprise programmable logic or circuitry (e.g., as encompassed within a general-purpose processor or other programmable processor) that is temporarily configured by software to perform certain operations. It will be appreciated that the decision to implement a controller mechanically, in dedicated and permanently configured circuitry, or in temporarily configured circuitry (e.g., configured by software) may be driven by cost and time considerations.

Accordingly, the terms controller or processor or hardware module should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which controllers are temporarily configured (e.g., programmed), each of the controllers need not be configured or instantiated at any one instance in time. For example, where the controllers comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Controllers can provide information to, and receive information from, other controllers. Accordingly, the described controllers may be regarded as being communicatively coupled. Where multiple of such controllers exist contemporaneously, communications may be achieved through signal transmission (e.g., over appropriate circuits and buses) that connect the controllers. In embodiments in which multiple controllers are configured or instantiated at different times, communications between such controllers may be achieved, for example, through the storage and retrieval of information in memory structures to which the multiple controllers have access. For example, one controller may perform an operation, and store the output of that operation in a memory device to which it is communicatively coupled. A further controller may then, at a later time, access the memory device to retrieve and process the stored output. Controllers may also initiate communications with input or output devices, and can operate on a resource (e.g., a collection of information).

The various operations of example systems described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the system and methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

While this disclosure makes reference to exemplary embodiments, it will be understood by those skilled in the art that various changes in form and details may be made therein without departing from the scope of the claimed embodiments.

What is claimed is:

1. A conditionally transparent touch control surface, comprising:
a base layer;
a display layer, wherein the display layer includes a plurality of display areas each with an OFF state and an ON state; and
a surface layer, wherein the surface layer covers the plurality of display areas, and wherein each display area is visible through the surface layer only while that display area is in the ON state;
a controller is configured to control the change of each the display areas from the OFF state to the ON state based on sensing a condition of a person interacting with the control surface;
wherein the ON state for at least one of the display areas includes a plurality of different display conditions and each of the display conditions corresponds to a different image being displayed on the display area and through the surface layer; and
wherein the layers of the control surface are flexible and contour to the shape of an interior surface of the vehicle.

2. The touch surface of claim 1, wherein the display area includes a mechanical switch configured to receive and detect input from the person.

3. The touch surface of claim 1, wherein the display area is connected to a capacitive touch circuit configured to receive and detect input from the person.

4. The touch surface of claim 1, further comprising a proximity sensor connected to the controller.

5. The control surface of claim 1, wherein the display layer is a touchscreen including a plurality of display areas each with an OFF state and an ON state.

6. The control surface of claim 2, wherein the mechanical switch includes a screen.

7. The control surface of claim 1, wherein at least one display area in the plurality of display areas corresponds to a function.

8. The control surface of claim 7, wherein the correspondence of the at least one display area to a function is reconfigurable.

9. The control surface of claim 8, wherein the at least one display area displays an icon related to its corresponding function.

10. The control surface of claim 9, wherein the icon of the at least one display area is reconfigurable.

11. The control surface of claim 1, wherein the display area management system controls the at least one display area to switch between the ON state and the OFF state based on a tracked eye movement of a user.

12. The control surface of claim 4, wherein the display area management system controls the at least one display area to switch between the OFF state and the ON state based on input from of the proximity sensor.

13. A vehicle having a vehicle interior including a conditionally transparent touch control surface comprising:
a base layer;
a display layer, wherein the display layer includes a plurality of display areas each with an OFF state and an ON state; and
a surface layer, wherein the surface layer covers the plurality of display areas, and wherein each display area is visible through the surface layer only while that display area is in the ON state;
wherein the display layer is directly between the base layer and the surface layer;
a first controller is configured to control the change of each the display areas from the OFF state to the ON state based on sensing a condition of an occupant interacting with the control surface;
wherein the ON state for at least one of the display areas includes a plurality of different display conditions and each of the display conditions corresponds to a different image being displayed on the display area and through the surface layer;
wherein the layers of the control surface are flexible and contour to the shape of an interior surface of the vehicle; and
wherein the display areas is configured to communicate with a central controller configured to communicate with vehicle systems of the vehicle.

14. The vehicle of claim 14, wherein the vehicle systems include at least one of a phone system, an audio system, a climate system, and lighting system.

15. The vehicle of claim 14, wherein the display area includes a mechanical switch configured to receive and detect input from the occupant.

16. The vehicle of claim 14, wherein the display area is connected to a capacitive touch circuit configured to receive and detect input from the occupant.

17. The vehicle of claim 14, further comprising a proximity sensor connected to the first controller.

18. The vehicle of claim 14, wherein the display layer is a touchscreen including a plurality of display areas each with an OFF state and an ON state.

19. The control surface of claim 1, wherein at least one display area in the plurality of display areas corresponds to a function.

20. The control surface of claim 7, wherein the correspondence of the at least one display area to a function is reconfigurable.
